(19) United States
(12) Patent Application Publication
(10) Pub. No.: US 2025/0118336 A1
(43) Pub. Date: Apr. 10, 2025

(54) Automatic Dubbing: Methods and Apparatuses

(71) Applicant: Applications Technology (AppTek), LLC, McLean, VA (US)

(72) Inventors: Mattia Antonino Di Gangi, Aachen (DE); Alejandro Pérez, Valencia (ES); Nick Rosenbach, Aachen (DE); Jintao Jiang, Great Falls, VA (US)

(21) Appl. No.: 18/911,200

(22) Filed: Oct. 9, 2024

Related U.S. Application Data
(60) Provisional application No. 63/543,232, filed on Oct. 9, 2023.

(51) Int. Cl. G11B 27/031; G06F 40/58; G06V 40/16; G10L 13/033; G10L 13/07; G10L 13/10; G10L 17/02; G10L 21/028; G10L 25/57; G10L 25/63; G10L 25/93

(52) U.S. Cl. CPC G11B 27/031; G06F 40/58; G06V 40/161; G10L 13/033; G10L 13/07; G10L 13/10; G10L 17/02; G10L 21/028; G10L 25/57; G10L 25/63; G10L 25/93

(57) ABSTRACT

Automatic video dubbing methods and apparatuses automatically dub a video signal into a different target language than the original while controllably preserving vocal characteristics of original speakers in the corresponding audio, based on separating audio from the video, preserving audio timings, separating voice and non-voice segments from background noise, and using ASR, MT and signal processing techniques to generate properly sized and selectable speech translations into different languages corresponding to speaker voices in the video and emotions, voice and/or textual characteristics.

### CROSS REFERENCE TO RELATED APPLICATIONS

This application claims priority to U.S. Provisional Patent Application No. 63/543,232, filed on Oct. 9, 2023, entitled “Automatic Dubbing: Methods and Apparatuses, the entirety of which is incorporated by reference herein.

### FIELD OF THE INVENTION

The present invention relates generally to performing cross-lingual automatic dubbing, and more particularly to performing cross-lingual automatic dubbing of a multimedia digital signal that may include video, audio and other effects.

### BACKGROUND OF THE INVENTION

The amount of video content produced daily is huge and constantly growing. There is plenty of media content in the form of movies and other kinds of shows by classic cinema and TV producers, as well as relatively new actors in the video streaming scene. Moreover, online video platforms have millions of daily viewers and content creators. Social networks have also moved towards a type of interaction based on videos rather than other communication forms.

Video fruition is in many cases limited by language understanding. Large cinema and TV producers have a large budget and can easily afford dubbing for a broader reach of selected movies and shows. However, this process is generally expensive and there is no standardized pricing in the industry, and it is as such not affordable for small actors. The cost-efficient option for them is to use subtitles to internationalize their shows. Subtitles are cheaper than dubbing, and can also be automated in many respects nowadays, reducing their price further.

However, watching a show with dubbing or with subtitles are two different watching experiences. With subtitles, the audience is forced to read all the time if they do not understand the audio language. As such, subtitles can be a hindrance to fully enjoying a show, since the attention is continually split between watching the scene and reading the lower side of the screen. On the other hand, a drawback is that many people do not appreciate dubbing because of the adaptations it forces to the language in order to fit the constraints given by the scenes.

From an accessibility point of view, subtitles are of no help with visually impaired or blind people, and it can be problematic for people suffering from dyslexia or just slow when reading in a different language. In fact, subtitles may not be available in all languages and viewers may be forced to pick one language they understand, which is not their native language. Dubbing is instead not useful for deaf or hard-to-hear people, who need subtitles to follow the dialogues.

In addition to the previous points, the preference for subtitling or dubbing is also cultural, with countries opting for (and being used to) one of the two options. In some countries, the broad population is just used to watching everything in their native language, being it original or dubbed content, and watching a show with subtitles would not be considered an option. Considering everything, dubbing has the potential to increase considerably the reach of video content. If it can satisfy quality and cost requirements, automatic dubbing can enable industry players of all sizes to increase the internationalization of their videos through dubbing.

### SUMMARY OF THE INVENTION

The invention is based on State-of-the-Art (SOTA) technology for several tasks in signal processing and natural language processing. Given a video signal in input, an automatic dubbing system requires high accuracy in, at least, the following tasks: automatic speech recognition (ASR) for transcribing the speech from the signal; source separation to separate speech and background signal and reintroduce the background in the final video; machine translation (MT) to obtain text in the target language; and text-to-speech synthesis (TTS) to generate the utterances in the target language.

Low accuracy in one of the abovementioned components would compromise the overall quality of the final video, but high accuracy is not enough as well, and some task-specific challenges need to be considered to make the viewing experience pleasant for the audience. Additionally, given the high number of components, it becomes relevant to consider some tradeoffs between accuracy and total processing time. In fact, while processing times are still lower than what humans could achieve, in many cases also considered in this disclosure, the fully automated process is just a first step before human intervention. And longer processing will increase costs and delay the start of human work.

Speaker diarization is a component that segments an audio signal according to the speaker. Given that in general the number of speakers is not known in advance, finding the most probable number of speakers is also part of the task, which makes it particularly hard. The result of transcribing the audio signal depends on the quality of the ASR, diarization, audio segmentation and text punctuation components, but also by the way they interact with each other. One effective way would be to first perform diarization, then speech recognition on single-speaker segments, and finally punctuation on each of those segments. However, ASR and diarization are both computationally expensive components with RTF˜0.5 each when computed on modern CPUs. The concatenation of these two components would lead to an RTF of ˜1. The availability of multiple compute nodes allows computing the two operations in parallel and then merging the results before applying punctuation. The scores of the language model will be wrongly influenced from the words of another speaker at the borders between two speakers but the RTF is halved in practice.

A similar problem arises with source separation. This is another computationally expensive component with an RTF of ˜0.5 on modern multicore CPUs. If the transcription is done on the enhanced speech signal obtained from source separation, the result should be higher than recognizing from a noisy signal. Yet, the spectral representation of enhanced speech signals is different from recorded signals and ASR systems need to be trained on this kind of signals to benefit from them. In some applications, the increased effort and RTF is not worth the gain in transcription quality, and the recognition can be performed on the original audio while source separation runs in parallel in another computing node.

Machine translation is one of the most studied components in automatic dubbing literature. The reason is that translations need to be accurate, but also uttered by the TTS system under time constraints. The constraints are given by the lip movements when the speaker is in foreground, and by the surrounding sentences timings in all cases. To achieve such goals, MT models are enhanced to output translations of the given length, or to predict pauses in a sentence in order to reproduce the prosody from the original speech. In the present disclosure we include these features, and we also add metadata-aware translations to speed up the translation post-processing by easily changing aspects like gender, style, or politeness. Some metadata, like speaker gender, can be detected automatically to have higher translation quality in the first dubbed video, but others become relevant mostly for postediting.

The TTS component needs to pronounce the words correctly and the voice should sound somehow like the original. In some cases, a cloning of the original voice is required by the user while in other cases just a voice that fits the gender can be good enough. TTS with the speaker voice can be achieved in at least two ways. The first approach considered in the present disclosure is to use speaker-adaptive TTS, which takes as an additional input a feature vector representing the speaker voice's characteristics. The system learns to pronounce the text with a voice that reproduces the encoded one. The second option is to use a more classical approach to TTS with fixed voices, and cascade it with a voice conversion model, which takes in as input a speech signal with the speech and a second speech signal with a reference voice, and outputs the same speech with the reference voice. This second approach requires an additional model but decouples the problem of producing high-quality, emotional voices from the problem of producing the desired voice.

The bridge between MT and TTS is a component we call speech placement, which decides the actual timing to assign to each utterance. It uses translated texts, the original timing and the time requested to utter the sentences with the desired voice. What it does is to assign the actual time stamps to each utterance and decide if it should be sped up or slowed down.

Image processing models are also included in our automatic dubbing pipeline for several tasks. A speaker detection system detects lips movements in the video images to provide an a priori probability of the number of speakers. This information is used to narrow the range of speaker numbers to be considered by the diarization system. Scene cut detection is another technology that does not require machine learning and can predict accurately the scene changes. It can help to further narrow down the range and get more accurate results. Additionally, speaker detection provides a priori probabilities for the speaker changes, which are particularly difficult to detect for current speaker diarization systems when one speaker turn is very short (less than 2 seconds). This can sound like a corner case, but it improves the overall viewing experience, as a missed speaker change means for the viewer that two characters in the video speak with the exact same voice. This may result in lost viewer's trust in the automatic system.

According to an embodiment of the invention, a method of speaker-adaptive dubbing of an audio signal in a video into different languages includes:
receiving translated text in a target language, an original audio stream, and at least one speaker feature vector corresponding to at least one speaker represented as speech in the original audio stream, wherein the original audio stream includes speech in a first language different from the target language; and
synthesizing voices in the target language based on the at least one speaker feature vector corresponding to at least one speaker in the original audio stream so that the synthesized voices in the target language controllably sounds like the at least one speaker in the original audio. The method may further include generating emotional label information based on speech and/or text in the first language on which the voice synthesis is also based. There are many additional variations including identifying speakers by their speech or images in audio and video segments being processed described in further detail below.

### BRIEF DESCRIPTION OF THE FIGURES

The above described features and advantages will be more fully appreciated with reference to the below figures, in which:

FIG. 1 depicts a high-level view of a dubbing system.

FIG. 2 depicts a microservice architecture for dubbing a video in another language according to an embodiment of the invention.

FIG. 3 depicts a high-level workflow of an embodiment for processing and dubbing a video in another language according to an embodiment of the present invention.

FIGS. 4A-4E depict the functionalities associated with media conversion.

FIG. 5 depicts a speech separation system that according to an embodiment of the invention is a combination of two systems that run in parallel.

FIG. 6 depicts a speech separation system based on a cascade of speech enhancement and signal subtraction components.

FIG. 7 depicts a scene detection system that processes adjacent image frames.

FIG. 8 depicts a functional block diagram of a speech recognition process that receives audio and produces processed transcripts of speech in the audio.

FIG. 9 depicts a visual diarization system according to an embodiment of the invention.

FIG. 10 depicts an emotion classification system according to an embodiment of the invention.

FIG. 11 depicts a functional block diagram of a fully-fledged context-aware, length-controlled and metadata-aware machine translation system according to an embodiment of the invention.

FIG. 12 depicts a functional block diagram of a path to extract speaker vectors, according to an embodiment of the invention.

FIG. 13 provides an exemplary illustration of speech placement when the translation is longer than the source sentence, according to an embodiment of the invention.

FIG. 14 provides exemplary illustration of speech placement when the translation is longer than the source sentence, but no silence is available around it in the source audio signal, according to an embodiment of the invention.

FIG. 15 depicts a functional block diagram of TTS with speech placement, according to an embodiment of the present invention.

FIG. 16 depicts a functional block diagram of TTS using translated text according to an embodiment of the invention.

FIGS. 17A-17C shows various TTS models, inputs and outputs according to some embodiments of the invention.

FIG. 18 depicts an illustration of how TTS may be connected to various components of different embodiments to vocalize text according to some embodiments of the invention.

FIG. 19 depicts an example of a source-language sentence matched with valid translations of three different lengths according to an embodiment of the invention.

FIG. 20 depicts an illustrative block diagram of a process for training speaker-adaptive TTS according to an embodiment of the present invention.

### DETAILED DESCRIPTION

The present disclosure relates to methods, systems, apparatuses, and non-transitory computer readable storage media for automatic dubbing and voiceover.

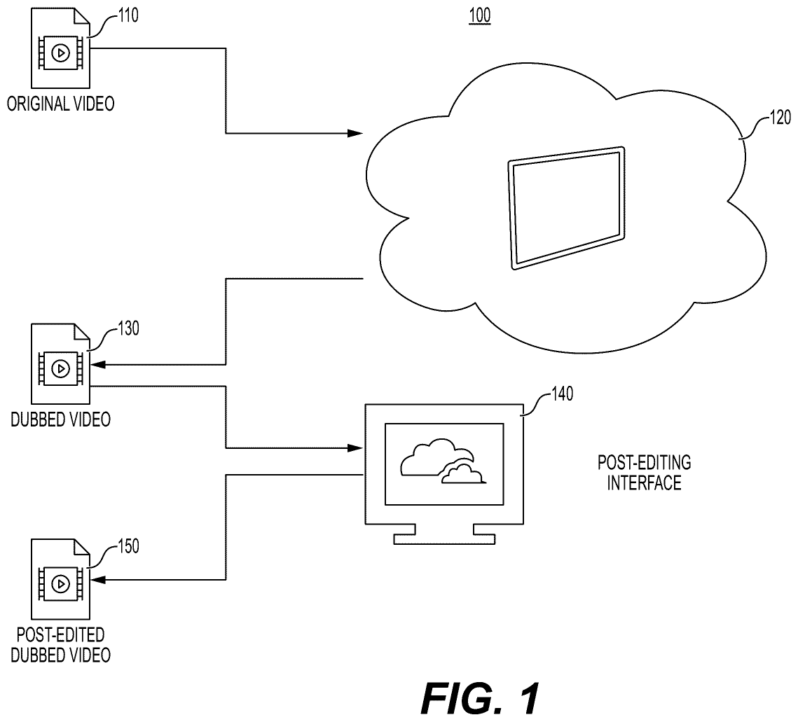

According to some embodiments, the system may be configured as a cloud service that works in two subsequent phases. For example, FIG. 1 depicts a high-level view of a system 100. Referring to FIG. 1, a video signal 110 may be first sent through the network to an automatic dubbing service 120 resulting, which produces a video signal output with dubbed audio content 130. Then, the user can use a GUI 140 provided as SaaS to post-edit the video signal under many aspects described below and obtain a final version of the video 150. As depicted in FIG. 1, in the first phase, the automated dubbing service may be an automated pipeline as described herein according to one or more embodiments of the present invention that produces an output dubbed video signal. In the second phase, a user may work in a post-editing interface to modify the generated content and improve the final dubbed video. The generated and edited content according to an embodiment of the invention may include automatic transcriptions, translated sentences and synthesized voices utterances, all including additional information such as a speaker label or word and sentence timings. The output of this phase is a high-quality post-edited dubbed video signal. The transcription service and the terminal for post processing may access cloud services or may run software that is resident in memory and a processor that executes program instructions from the software to implement the components and processes described herein.

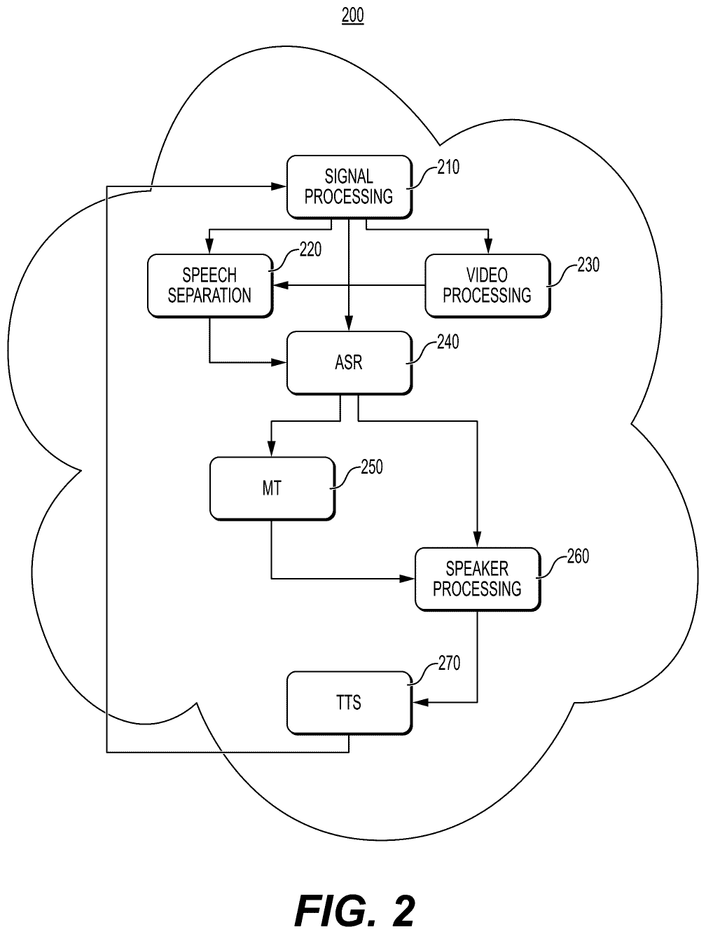

According to some embodiments, a multimedia signal such as a video is transmitted through a network to the automatic dubbing system 200 residing in the cloud, as depicted in FIG. 2. Referring to FIG. 2, an embodiment of the system may be deployed with a microservice architecture as shown for deployment of dubbing according to some embodiments. The signal processing service 210 may receive video signals and dubbing signals and perform signal-related operations such as extracting an audio signal from video signal, concatenating multiple audio signals together, blending multiple audio tracks in a single signal, and merging the output audio signal with the original video. The signal processing 210 may provide output to a speech separation service 220, an automatic speech recognition service (ASR) 240 and a video processing service 230.

The images separated from the video signal may be transmitted to the video processing service 230 that runs the person detection and speaker detection components. The audio signal extracted by the signal processing component is transmitted to the source separation service 220 that only includes the source separation components, such as speech. The output from speaker detection can also be used here as described above. The ASR service 240 includes audio segmentation, ASR, punctuation and diarization systems. Its output is sent to an MT service 250 and speaker processing service 260. The MT service runs the MT system, and the speaker segmentation is sent to the speaker processing service. It can compute translation durations, compute a speaker embedding for each speaker identified by diarization and run speech placement. The speaker processing service 260 outputs information to a TTS service 270, which performs speech synthesis and emotion classification. Then the generated audio signals are sent back to the signal processing service 210 to concatenate them, merge them with the background and render the final video.

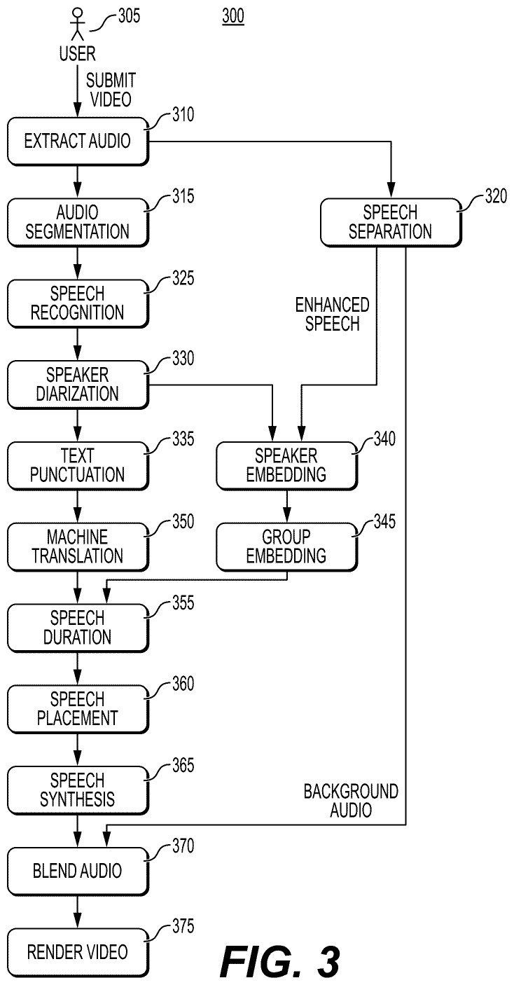

FIG. 3 illustrates a flowchart of a full automatic dubbing pipeline according to some embodiments of the invention. It follows the description below, but it will be understood that while one illustrative embodiment is provided, there are many variations that one of ordinary skill in the art will appreciate are within the spirit and scope of the invention. Referring to FIG. 3, a high-level workflow of an embodiment of a dubbing system 300 is shown. A user 305 may submit a video to the system. An audio signal is extracted from the video in 310 and sent to two distinct services. On one side it is input to a speech separation block 320, which outputs an enhanced speech signal and a background audio signal. On the other side, the output is sent to an audio segmentation block 315, which uses Voice Activity Detection to detect speech/non-speech segments. The speech segments are then received and recognized by Automatic Speech Recognition (ASR) block 325. The speakers are detected by Speaker Diarization block 330, and the transcriptions split by speaker are then annotated with punctuation by Text Punctuation block 335. The punctuated text may then be input to a Machine Translation block 350 to obtain sentences in a target language different from the source language.

A Speaker Embedding Block 340 may receive enhanced speech output from the speech separation block 320 and output from the speaker diarization block 330. These audio signals segmented by speaker are input to Speaker Embedding to extract speaker vectors. Then in a Group Embedding block 345, which receives output from the Speaker Embedding Block, a representative speaker vector is selected for each speaker. Such speaker vectors are input together with translations output by the Machine Translation block 350 to a Speech Duration block 355 to predict the duration of the resulting synthesized speech signal. Given the durations and the original times from the Speech Duration block, a Speech Placement block determines start and end times for each of the synthetic speech signal, plus a possible tempo rate to speed up or slow down the signal.

Translated sentences with the respective speaker vectors and placement results are then input to a Speech Synthesis block 365 to obtain the individual synthesized audio signals for each sentence, representing translated speech within the audio signal. These signals are then concatenated and blended with the background audio signal from block 320 to obtain a single audio signal in Blend Audio block 370. The result is then merged with the source video in Render Video to produce a dubbed output video in a target language different than the source language in 375.

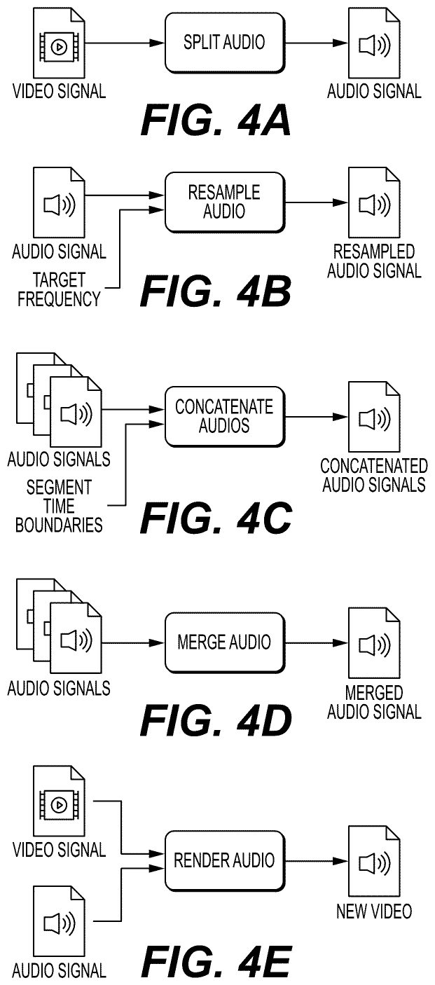

FIGS. 4A-4E depict functionalities of media conversion according to some embodiments of the invention. All the functionalities may use ffmpeg for signal processing to handle and manipulate signals. For example, Split Audio takes as input a video signal and produces in output the audio signal contained in it. Resample Audio takes in as input an audio signal and a target frequency, and generates a new audio signal with the same content but resampled with the target sampling frequency. Concatenate Audio takes as input a list of audio signals and a list of time boundaries of the same length. It generates a new audio signal where the original signals are located in time boundaries passed as input and the time between consecutive signals are filled with silence (zero energy signal). Merge Audio takes in as input multiple audio signals of the same duration and sums them, with an optional volume factor for each, to generate a new audio signal. This may be used, for instance, to merge synthesized voices with the background signal. Render Video takes in as input a video signal and an audio signal and generates a new video signal where video images come from the input video signal and the audio for the video from the input audio signal.

Referring to FIGS. 4A-4E, a multimedia signal is received from a network and stored in a storage device. Then, the audio signal is extracted from the video signal and stored separately. In some embodiments, the audio signal is resampled to 16 kHz for compatibility with some following components, such as automatic speech recognition (ASR) and source separation. In some embodiments, such services may be implemented by calling appropriately the popular tool ffmpeg.

For example, the audio signal may then be processed by a source separation component, which creates two new audio files, one file with the speech signal and one file with the background signal, which includes noise and music among other types of background audio signals. In some embodiments, speech separation is deployed as a microservice in the cloud. In some embodiments, speech separation consists of a single or distributed deep learning model that receives an audio signal in the time domain as input and produces as output the two signals for speech and background. In some embodiments, the model transforms the signal into the frequency domain and then transforms the output back into the time domain.

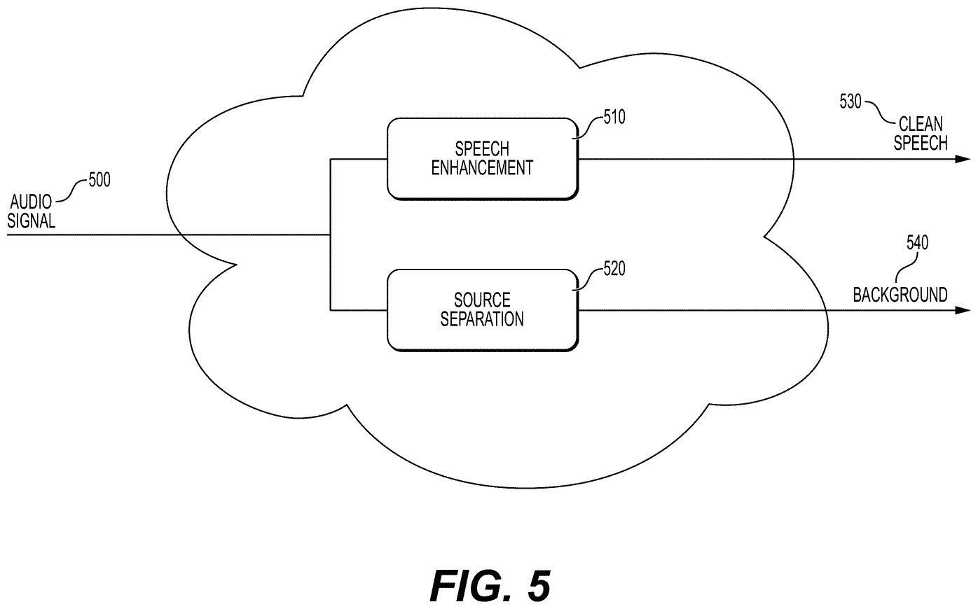

FIG. 5 depicts speech separation processes as a combination of two systems 510 and 520 built around deep learning models that run in parallel. A separate source separation model 520 extracts the background signal. In some embodiments, the speech separation component consists of a speech enhancement model and a source separation model, as depicted in FIG. 5. The speech enhancement model 510 processes an audio signal and outputs an audio signal with the noise attenuated or removed. In some embodiments, the signal is transformed into the frequency domain before processing and back to the time domain in output. The source separation model may know or have be trained to learn a predefined set of sources (e.g. human voice, musical instruments, ambient noise), and may separate the input signal into the components given by the sources.

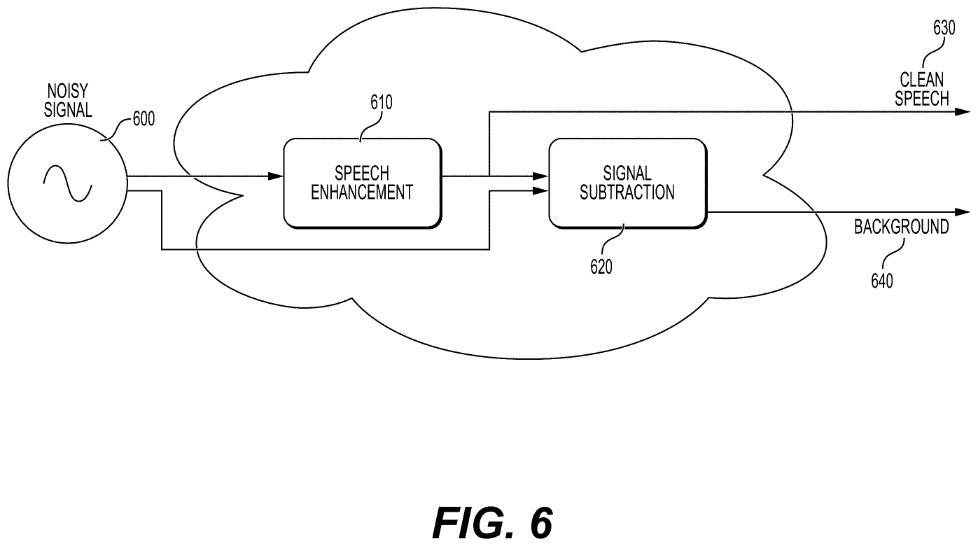

FIG. 6 depicts speech separation as a cascade of speech enhancement 610 and signal subtraction 620 components. The speech enhancement component may be built around a deep learning model for the task. Signal subtraction may use a classic algorithm like spectral subtraction. In some embodiments, the speech separation component consists of the speech enhancement component followed by the signal subtraction component that removes the clean speech signal from the input signal to obtain the background signal only, as depicted in FIG. 6. Some embodiments may use the spectral subtraction algorithm.

The embodiments using source separation may use a deep-learning-based system for speech enhancement to extract the clean speech, and a different deep-learning-based system for source separation to extract the clean background. This requires more computation than signal subtraction but is also more accurate. The accuracy advantage is twofold. First a deep learning model may generate higher-quality signals than a simplistic signal processing algorithm; second, it enables the usage of speech enhancement that removes, or strongly attenuates, reverberation. In fact, when the background is obtained by signal subtraction, the original speech is reverberated but the clean speech is not, then reverberation leaks into the background. This problem does not arise when the two signals are extracted separately according to an embodiment of the present invention.

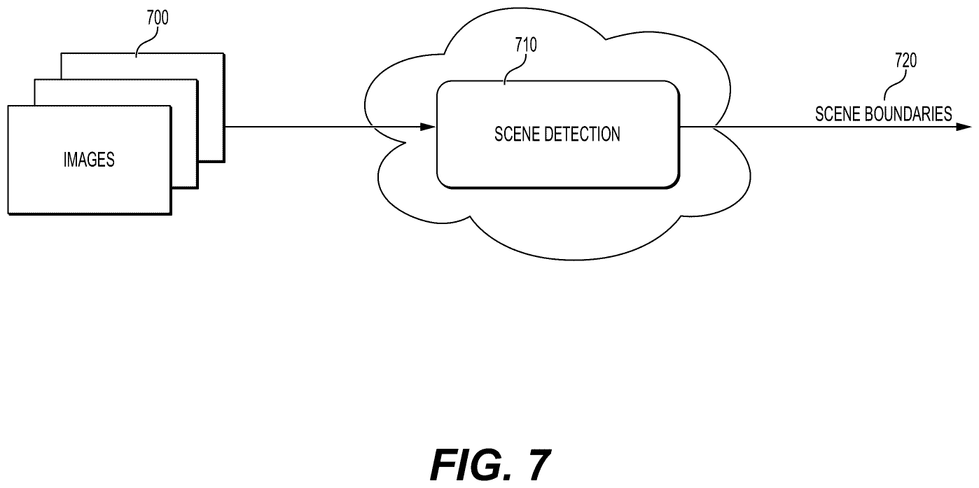

FIG. 7 depicts a scene detection system that may include a scene detection program 710 that computes a difference between adjacent image frames 700 and outputs scene change information 720, such as boundaries, when this difference passes a threshold. In some embodiments, a scene detection system may segment the video signal according to scene changes, depicted in FIG. 7. Such a system takes in input the sequence of images constituting the video and outputs clusters of consecutive frames 720 all belonging to the same scene. The timestamps corresponding to the initial and final frames of each scene may also be part of the output.

The audio signal is then processed by an ASR system to obtain the text with the corresponding word timings. According to some embodiments, the input audio signal is the one that was originally extracted from the video. In such embodiments, the ASR system may be trained using audio data that includes both speech and the background signals. In some embodiments, the ASR system may be trained with speech signals obtained from speech enhancement or source separation systems. In such embodiments, the ASR component receives as input speech signals output by the source separation component.

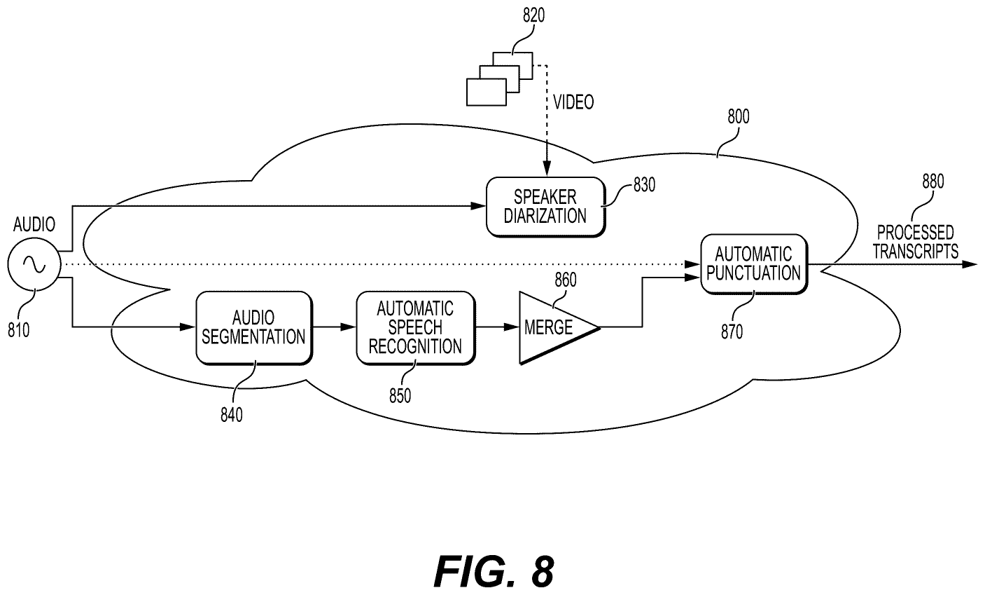

FIG. 8 depicts components in a speech recognition service. The audio signal 810 is processed by the actual speech recognition system 850 and by the speaker diarization system 830. The audio signal is segmented according to, for example, silence from a speech segmentation system 840 and only then passed forward to speech recognition. The speech recognition system 850 outputs a sequence of recognized words and their relative time stamps, whereas the speaker diarization system outputs segments divided by speaker. The speaker diarization system can additionally use information from the images in the video signal 820 to improve accuracy. The segments from speaker diarization are used to segment the output of speech recognition in 860. Then, the segmented text, which is lowercase and without punctuation, is passed as input to the automatic punctuation system 870 to add proper casing and punctuation. This last step makes the text, processed transcripts 880, more readable by humans and more easily translatable by the machine translation system.

In some embodiments, the automatic segmentation system 840 may split the audio signal into segments according to speech pauses, and the transcription is then performed on the speech segments. The ASR system 850 may generate the transcript of the audio signal in the form of a list of words without punctuation and time markers corresponding to the beginning and end of each word. The ASR system can be a hybrid HMM-DNN system or an end-to-end system in the form of attention encoder-decoder models, transducers or CTC models. In some embodiments that do not use automatic segmentation, the audio signal may be processed by the ASR component as streaming input and output. The audio signal is taken in input by the ASR component in potentially overlapping chunks of the full signal, and the output is produced while using the previous chunks and a “look-ahead” of future frames in a frame-synchronous manner. A speaker diarization system is used to assign audio windows, and their respective word sequences, to speaker labels.

The speaker diarization system may include a speaker encoder, which takes as input an audio signal and produces in output a single vector that represents the voice characteristics of the speaker in the given audio segment; a clustering algorithm, such as k-means or spectral clustering, that groups the resulting speaker vectors according to a similarity metrics; an optimization algorithm to determine the most probable number of clusters; and a gender classification system that takes as input the same audio signal as the speaker encoder, and produces in output a label ‘male’ or ‘female’ for the speaker. Some embodiments apply speaker gender classification on all the audio segments and then a majority vote determines the gender for the speaker. Some embodiments compute speaker gender classification only on the longest segment assigned to a speaker.

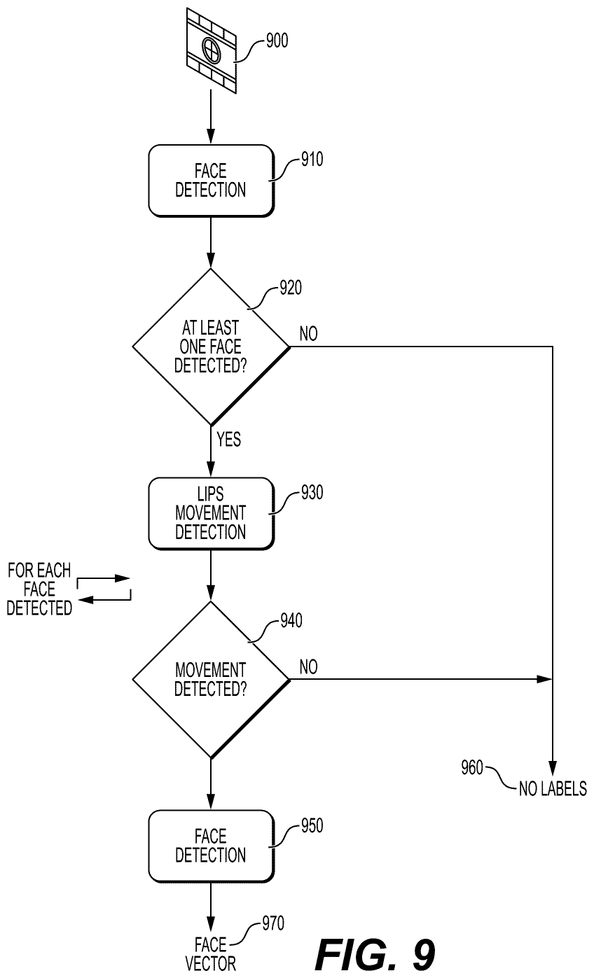

FIG. 9 depicts an illustrative visual diarization flow diagram. Image frames 900 from the video signal may be input as a sequence. The first step is a face detection in 910, which finds boxes in the images corresponding to faces, if any. If no faces are detected in 920, then no labels are assigned, and the frame can later be classified as “off-screen” if speech is recognized by ASR.

The sequences of frames with detected faces are input to a lip movement detection model 930 for processing. For all the consecutive frames where the same face is detected, decided according to position and plausible movements, the model detects if the corresponding lips move following a speech pattern across the frames. If no speakers are detected with moving lips in this way in 940, the image is discarded and becomes a candidate for “off-screen”. If one speaker is detected, then the face image is analyzed by a face recognition model in 950 that produces a vector encoding visual characteristics that can encompass sex, skin color, age, ethnicity and face traits useful to distinguish a person from another one.

Some embodiments use additional information from the images in the video to improve the diarization results. A visual diarization system detects the persons in a video signal and clusters them to find all the occurrences of a person in the video. According to some embodiments, as depicted in FIG. 9, the visual diarization system consists of three models that may implement deep learning: the face detection model 910 that receives an image signal input and produces in output the positions in the image of the faces, if any; the lip movement-detection model 930 that takes in input a sequence of images with detected faces in physically plausible positions, and for each face detects if its lips are moving; a face for which lips movement is detected is selected as a candidate speaker and a person recognition model 950 is run on the corresponding image signal to obtain in output a vector representing latent characteristics as sex, age, ethnicity and other characteristics useful to determine visual differences between persons.

The information about the persons and the lip movements is matched with the time boundaries for speech detected by the ASR system. In some embodiments, the segments from acoustic speaker diarization are then mapped to the labels from visual speaker detection using the time information from both. The resulting information is used together with the labels from both systems to assign more accurate speaker labels. In case of mismatch between the acoustics and the visual speaker, the system that during testing obtained the lowest error rate determines the label. In some embodiments, visual speaker detection is used to initialize the number of speakers for speaker diarization. Consecutive windows of the audio signal assigned speaker label are merged into a single segment.

An automatic punctuation system adds punctuation and proper casing to the output text from ASR. The input to this system consists of word sequences corresponding to segments detected during the diarization phase. This way, there is no contextual confusion between words spoken by different speakers. In some embodiments the punctuator receives as input only the text as output from the ASR system. In some other embodiments, the punctuator receives text and the corresponding audio signal as input, with the idea to use acoustic cues, such as pauses, to predict punctuation.

The information from ASR, punctuation and diarization is then merged into a data structure that includes the transcripts with the initial and final time stamps of each word, divided into segments, each segment with their timing and speaker. According to some embodiments, the present data structure is then stored into structured data formats such as xml or json for further post-editing.

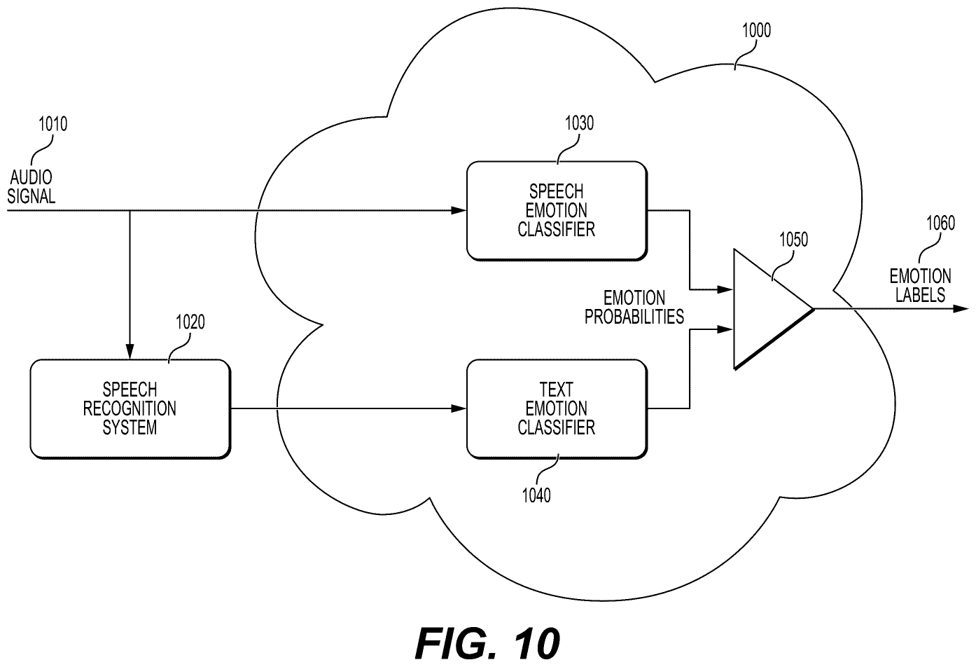

Some embodiments additionally use a speech emotion detection system to determine the emotions expressed in a sentence. Examples of emotions that can be expressed in speech are: happiness, sadness, anger, excitement, fear, surprise, or neutrality. In some embodiments, the output is a single emotion label for the whole segment. In some embodiments, the output is a set of weights for the various emotions. In some embodiments, the same output is computed at a word level using the word boundaries determined by the ASR system. Some embodiments additionally use a text emotion classifier, which takes as input a sentence in text format and produces in output emotion labels similarly to the speech detection system. The scores from the two systems are then combined with weights for a more accurate result. FIG. 10 depicts the case with emotion classification based on speech and text.

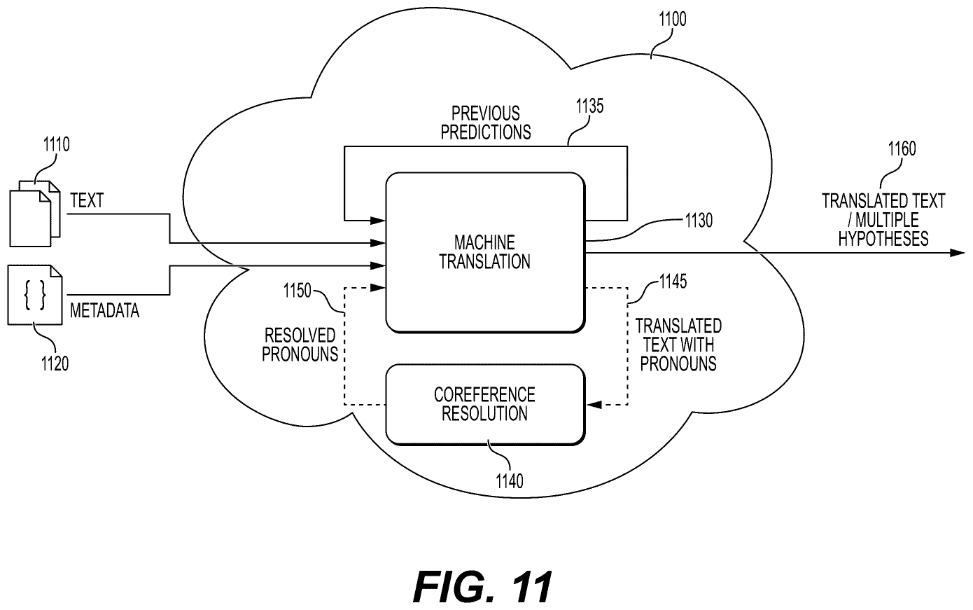

FIG. 11 depicts an embodiment of the machine translation (MT) component. The input coming into it is first converted from the output format of ASR into the format requested by the MT system. In some embodiments, the format is a subtitles file format, such as SubRip file format (srt). In other embodiments, it is plain text. Some embodiments add speaker information in the form of a speaker label and speaker gender. Some embodiments use a coreference resolution system to detect other persons mentioned in the sentence. Such embodiments also add a speaker label and a speaker gender for the other person. Some embodiments use information from the visual person detection system to detect what other persons are in the scene and increase their probabilities.

The MT system is trained to translate from the source to the target language. In some embodiments, the translation happens at a segment level, which may lack context for a proper translation. In some embodiments, the MT system can use information from the previous source text and/or translation for a better contextual translation. For proper video dubbing, it is required that the MT output can be uttered in the same timespan as the original utterance, and as such, some control in the output length is needed. In some embodiments, the MT model is trained to generate output of the same audio duration by using cross-lingual textual information such as character or syllable count. In some embodiments, the MT system is trained with utterance time information on both the source and target side to generate output that can be uttered at the same time as the input.

In some embodiments, the MT system receives as input also a speaker vector (described later) representing the speaker for the utterance and uses this additional information for predicting the utterance time. In fact, the time to utter a sentence varies from speaker to speaker also in automatic systems. In some embodiments, visual information from the video signal can be processed to predict if the speaker is off screen, in which case the timing is more relaxed.

In some embodiments, the N-best list from the MT system is retained to later choose the translation hypothesis that best fits the given time.

FIG. 10 depicts an emotion classification system 1000 according to an embodiment of the invention. It includes one emotion classifier 1030 that processes an input audio signal and one emotion classifier 1040 that processes text recognized by the speech recognition service 1020 such as that depicted in FIG. 8. These two classifiers produce emotion probabilities that are input to block 1050 that generates emotion labels 1060.

FIG. 11 depicts an illustrative, context-aware, length-controlled and metadata-aware machine translation system 1100 according to an embodiment of the invention. The input is twofold and consists of the text 1110 coming from the speech recognition service, and metadata 1120 associated with the text. Some metadata are document-level and others are sentence-level. Examples of metadata are the domain, the speaker gender, the dialect, but also required length for the output. A machine translation block 1130 receives the text, metadata, resolved pronouns and previous predictions 1135 and produces output of translated text 1160 with multiple hypotheses. A coreference resolution block 1140 receives pronouns output by the machine translation and generates resolved pronouns 1150 as input to the machine translation to identify references to the same entity, for example.

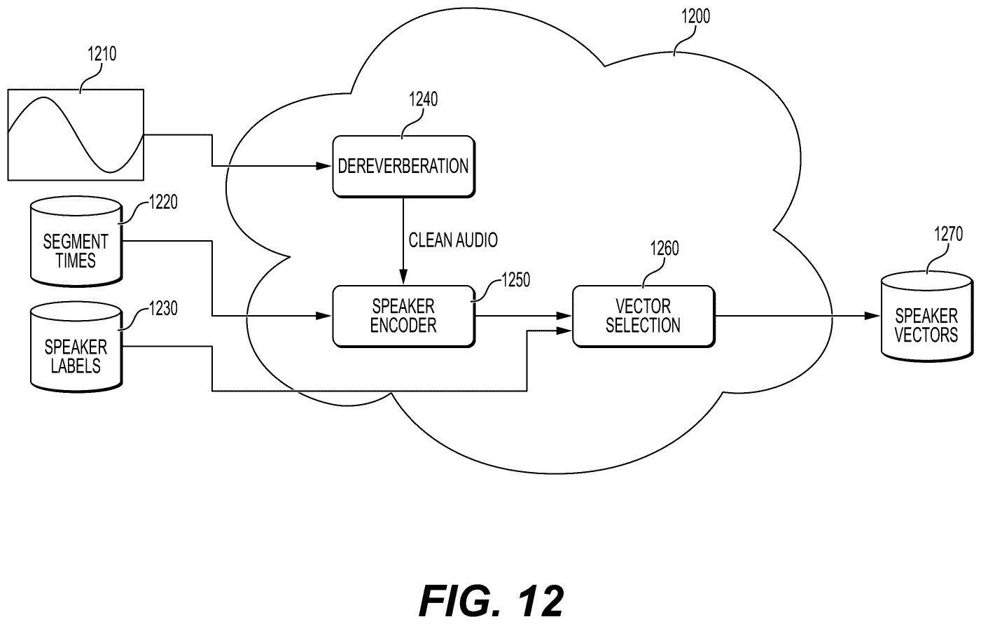

FIG. 12 depicts a path to extract speaker vectors. The input is given by the (enhanced) audio signal, time boundaries for each segment and speaker label, which may be obtained from speaker diarization, for each segment. The signal is firstly dereverberated to improve its quality. Then, the new signal is passed as input to the speaker encoder together with the other two inputs. For each segment delimited by the time markers, the speaker encoder extracts speaker vectors on multiple fixed size overlapping windows. The output of the speaker encoder is the average vector for each segment.

Referring to FIG. 12, a system 1200 selects and or determines a voice vector for each speaker. The voice vector encodes speaker characteristics like pitch, volume, timbre, or tone, which uniquely identify a person's voice. Its input is a sequence of time segments 1220, with start and stop time stamps, their speaker labels 1230, and an audio signal 1210 for each segment. This process uses a speaker encoder whose input is the audio signal from a segment and its output is a single vector for the segment. In some embodiments, the speaker encoder for this step is the same as the one used for speaker diarization. The input audio signal to the speaker encoder is the enhanced speech from the speech separation step, which prevents the speaker encoder from encoding the background noise together with the speech characteristics.

Some embodiments additionally compute the room impulse response (RIR) for each segment. This is based on algorithms that predict the reverberation in the signal and use it to estimate the RIR. Spectral subtraction and Wiener filter are among the algorithms commonly used for this task. The RIR from each segment is used to dereverberate the audio signal in 1240 and further improve its speech quality. Given a segment for which the speaker is known, the speaker encoder 1250 extracts vectors from consecutive, or overlapping, windows in it. The vectors obtained from the multiple windows are then grouped to obtain the speaker vector for the segment in 1260. For speaker vector selection in 1270, some embodiments use the vector obtained from this step as it is. Some embodiments, in order to have a consistent voice throughout the whole output video signal, group the speaker vectors for the same speakers to select one representative. Some techniques used for this step are: picking the feature vector corresponding to the longest segment for each speaker; computing an average vector; using the number of speakers found by speaker diarization to set the number of clusters for a clustering algorithm to run on the feature vectors, and picking the cluster centroids.

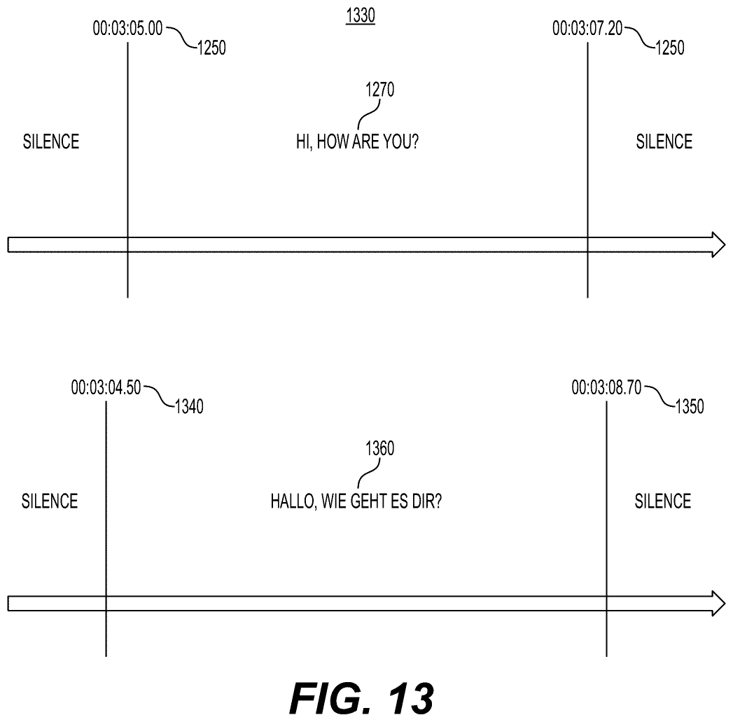

FIG. 13 shows an example of speech placement when the translation is longer than the source sentence, but it is surrounded by enough silence in the source audio signal. The translation can then be rendered with the original tempo rate by expanding on both sides at the expense of silence. FIG. 13 shows an example of stretching the target segment 1330 because the source segment is surrounded by enough silence.

The speech placement system decides the exact timing to assign to each sentence. Speech placement is designed according to the functioning of the TTS system. In some embodiments, the TTS system does not take as input the actual text but a phonemic representation of it. Then, the textual input is preprocessed with the TTS preprocessing pipeline to convert it into a phonemic representation and obtain a symbol-level duration. The speech placement system then determines the start and stop time of each segment, as well as a time correction factor for each word in order to expand or shrink its duration according to the time needs.

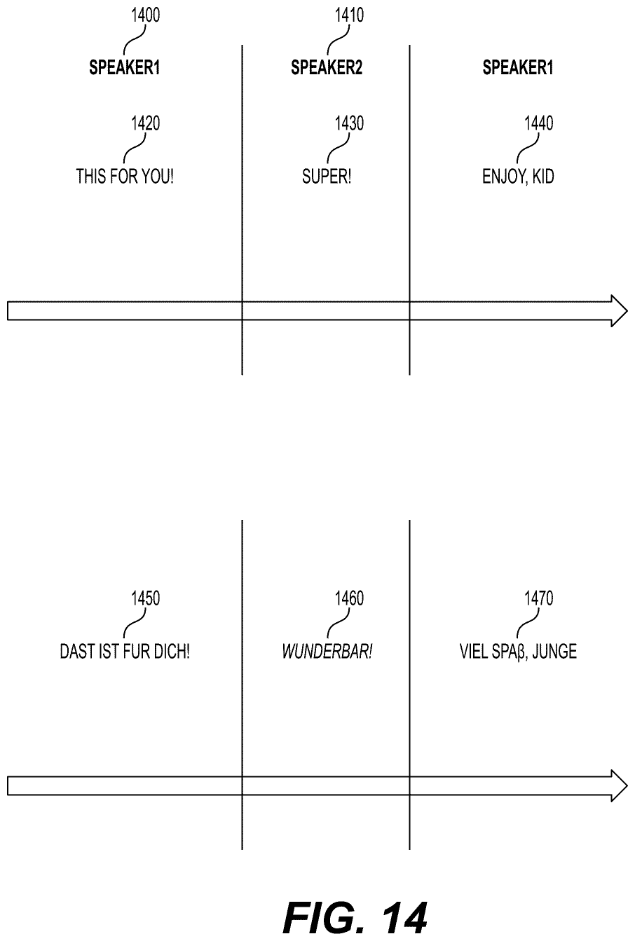

FIG. 14 shows an illustrative example according to an embodiment of the present invention of speech placement when the translation is longer than the source sentence, but no silence is available around it in the source audio signal. The synthesized voice then needs to be sped up by increasing its tempo rate to fit the same timing. Referring to FIG. 14, an example of speeding up a segment 1450 because the uttered translation is longer than the original 1420. The start and end times do not change but the correction factor is set to make the generated speech faster. In some embodiments, speech placement is performed with a greedy algorithm that decides the timing starting from the first segment and going forward till the last segment. In some embodiments, it is based on a multi-pass algorithm that first assigns the segments in a greedy way, then uses information from the multiple translation hypotheses to better fit the given time segments and prevent abrupt changes in speaking pace. Some embodiments use optimization algorithms such as genetic algorithms or ant-colony optimization to find the best placement by picking the MT hypotheses that best fit the given times and reduces the overall deviations from a normal speaking rate.

Some embodiments use a module to predict the speech rate. This module takes in input a text sequence and the corresponding audio signal, and outputs a single real number (speaking pace) indicating how much the speech content is slower or faster than a normal speaking rate. This number may then be multiplied or otherwise varied by the predicted duration of the synthesized audio to modify the duration accordingly. This helps to reproduce the original viewing experience in the target language when a sentence is pronounced purposedly too slow or too fast.

Such a pace prediction component is based on a duration model trained on words and their durations. The training data may be obtained starting from aligned audio-text data in the same language, and using a forced aligner to obtain word durations. Then, a Gaussian model may be trained to obtain mean and variance duration for each word. During inference, if a measured duration with an error interval given by a forced aligner has a probability according to the Gaussian model higher than a threshold t, then pace is set as 1, else it is the division of the duration measurement by the Gaussian mean.

In some embodiments, the MT model is trained to output sequences of phonemes and their respective duration. The training data may be prepared by starting from normal bilingual parallel text used for MT. The source side is left unchanged, but the target side is converted to phonemes using a grapheme-to-phoneme (G2P) model, and a duration model is used to annotate phonemes with duration. The duration model may be trained using audio-phonemes aligned data. In some embodiments, the output of MT is a sequence of pairs (phoneme, duration). The output sequence is then postprocessed to extract the phoneme and duration sequences separately and these sequences are fed as input to the TTS systems after speech placement and N-best selection from the previous points.

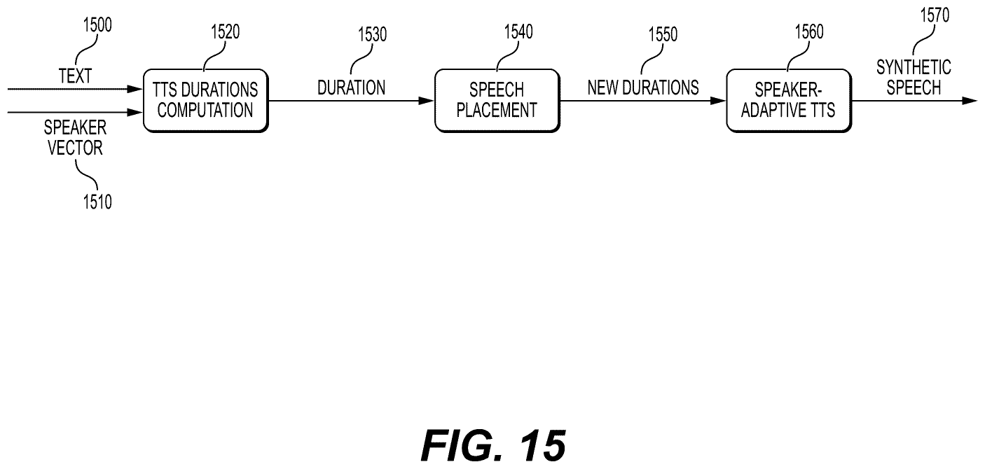

FIG. 15 depicts a combination of TTS with speech placement according to an embodiment of the invention. There is a component 1520 for predicting the utterance duration, usually the TTS encoder itself. These values are taken as input, together with the original durations, to compute in 1540 the tempo factors for each sentence. The tempo factor multiplies the original duration to obtain the final duration. Lastly, the text is used together with the tempo factor to synthesize voice in 1560 with the desired duration to produce synthetic speech 1570 for the new duration.

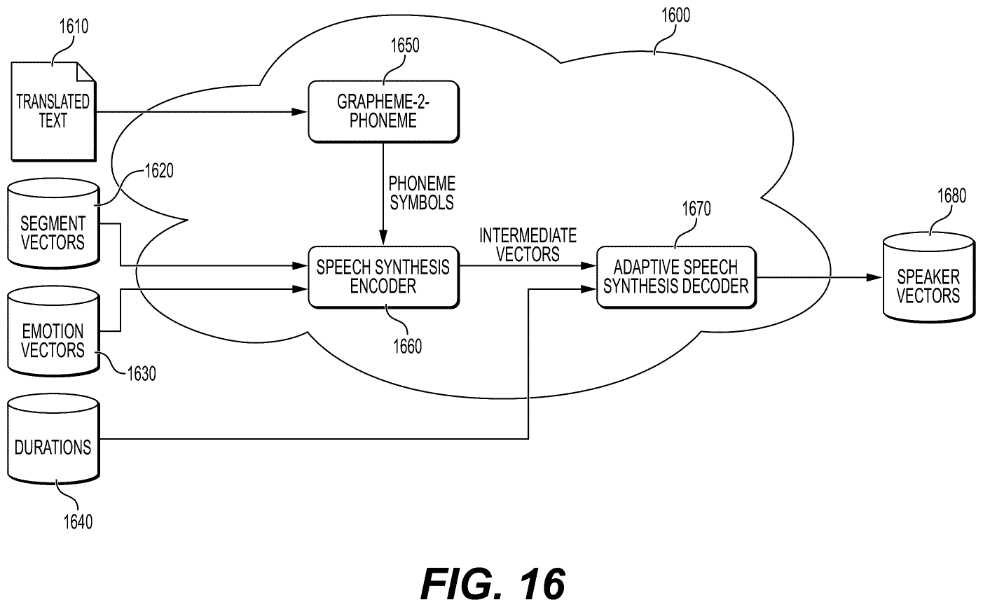

FIG. 16 highlights aspects of the speech synthesis (TTS) component 1600 according to some embodiments of the invention. The inputs are the translated text to utter 1610, speaker and emotion vectors 1620, 1630 and desired durations 1640. The text to utter is first processed by a grapheme2-phoneme component 1650 to transform it into phonemes. Such representation is used together with speaker and emotion vectors in 1660 to obtain an intermediate vector representation encoding the text and its duration. Finally, the TTS decoder 1670 uses the encoder output and the desired durations to generate the speaker vectors 1680 for synthetic voices.

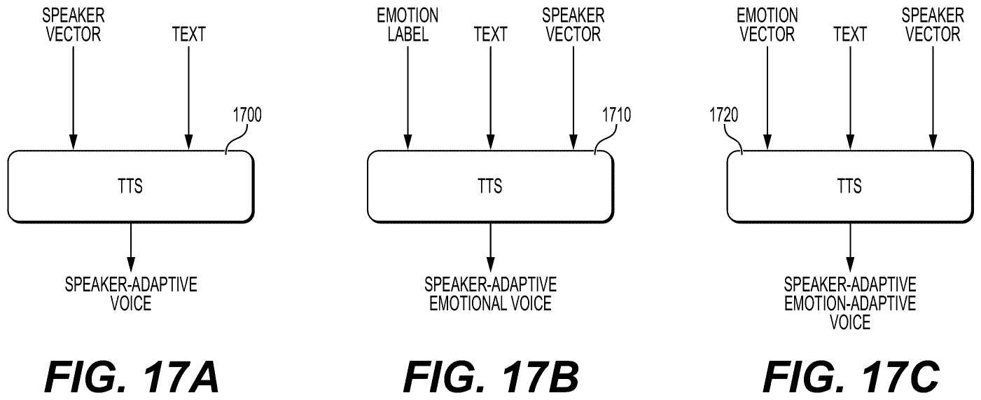

FIGS. 17A-17C shows a classification of TTS models according to the inputs they receive and how they generate audio signals. Speaker-adaptive TTS 1700 takes as input text to vocalize and a speaker vector corresponding to the voice to replicate and generate an audio signal with a voice replicating the one from which the speaker vector was extracted. Speaker-adaptive Emotional TTS 1710 adds an emotion label input to speaker-adaptive TTS, and the resulting output voice signal will reproduce the corresponding emotion with the same voice as the speaker-adaptive TTS. Speaker-adaptive emotion-adaptive TTS 1720 replaces the emotion label with an emotion vector, representing the nuances in the emotion spectrum of the original voice, as well as other latent characteristics representing the voice tone. The resulting synthesized voice signal reproduces the original voice timber as well as the tone used to utter the original sentence.

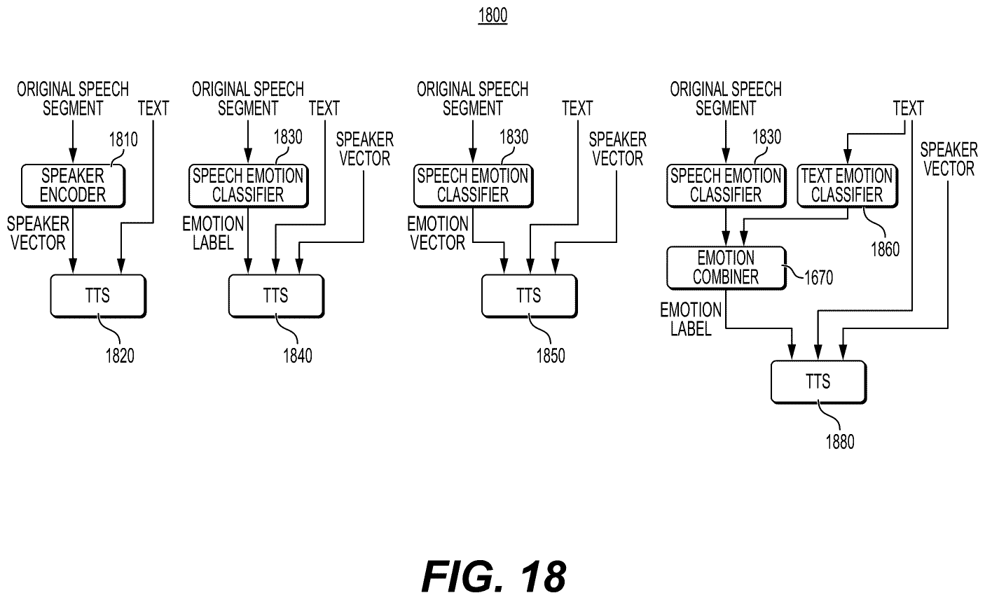

FIG. 18 depicts how TTS may be connected to other components for different embodiments. The speaker vectors are obtained applying the Speaker Encoder 1810 to the original audio signal segments. When we have speaker-adaptive emotional TTS, the label is obtained from the output of the speech emotion classifier 1830. In case of speaker-adaptive emotion-adaptive TTS, the emotion vector is the last vector produced by the speech emotion classifier 1830, before projecting it to the output probability space for emotion labels. When an emotion label is required in input, it can also be obtained combining in 1870 the output probabilities of a speech emotion classifier and a text emotion classifier. In all cases, the text to vocalize is the output of the MT system.

FIGS. 15-18 depict the speaker-adaptive TTS system according to some embodiments of the present invention. In some of them, the speaker vectors obtained from different sentences by the same speaker are grouped to obtain a single vector representing the speaker's voice characteristics. In some embodiments, the original audio for each segment is also given as an input to extract recording conditions from it. Some embodiments additionally receive an emotion vector that encodes speech emotions that are replicated in the synthetic sentence.

The synthetic audio files are then concatenated together while adding long-enough silence between the different segments. Silence is represented by a zero vector. In some embodiments, all synthesized audio signals are concatenated together, taking their timings into account. In some embodiments, following standards in the media industry, only synthesized voice signals with the same voice are concatenated together. These separate audio tracks can then be further used for professional mixing. Such embodiments also generate an additional audio signal that combines all the voice in a single track for generating a dubbed video automatically. The resulting audio file is then merged with the background audio in some embodiments, and with the background and a volume-scaled version of the original speech audio in other embodiments. The final audio file obtained by this latest merging is then added to the video and sent back to the user over the network.

Some embodiments also allow the user to modify intermediate output of the system. In such embodiments, the output artifact does not include only the output video signal, but may also include a data structure containing a sequence of segments, where for each segment it stores initial and final time, input audio signal, automatic transcript, machine translation, speaker label, speaker gender, detected emotion, on/off screen information, synthesized audio signal and phonemic representation of the audio signal or subsets or combinations thereof. Additionally, it maps speaker labels to speaker vectors and emotion labels to emotion vectors. Such data structure is then passed as input to a remote system that presents a GUI to the user. The GUI allows the user to edit all the information in it. In particular, it allows the user to change: the time markers of segments to fit more precisely the original utterances; the text of translations to utter with the synthesized voices, and of the transcriptions, which leads to better translations when they are requested into multiple target languages; the speaker labels to change voices easily; and the detected emotions to change the prosody of the synthetic utterance. Then, a button starts the generation of the synthetic audio for a segment given the edited data. The synthesized audio is generated with the same TTS system used for automatic dubbing and includes speaker and emotion adaptation as well. Some embodiments offer an additional interface to modify the synthesized audio by changing the pitch contour and duration of each phoneme.

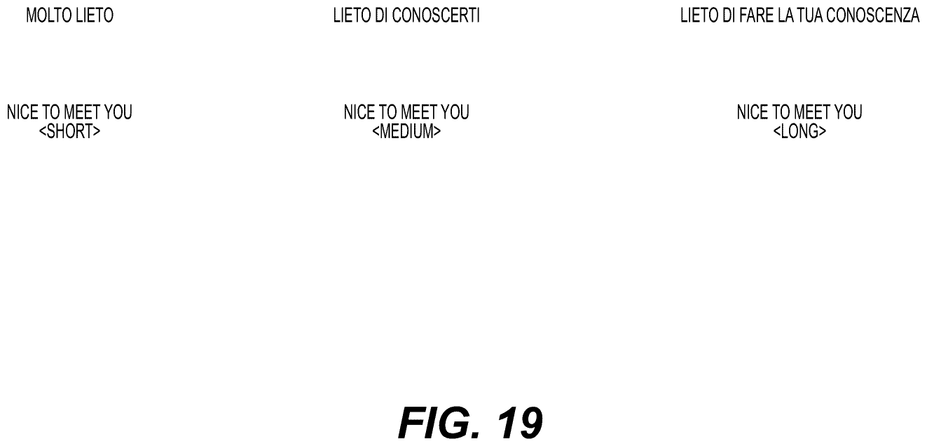

FIG. 19 depicts an example of a source-language sentence matched with valid translations of three different lengths. The source sentence is prepended by a tag representing the length difference of the same sentence with the target-language sentence. The training set of an MT system with length control consists of parallel corpora where the source side is augmented with a token representing the length difference. During inference, prepending a sentence with different tokens may result in different translations, each of different lengths.

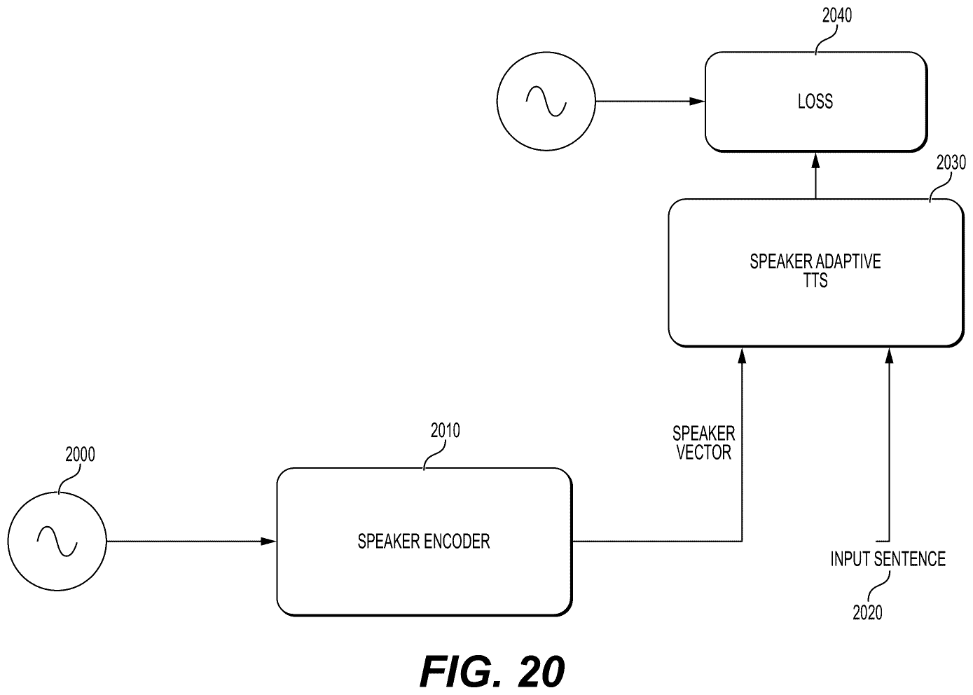

FIG. 20 depicts the training of speaker-adaptive TTS from a high level according to an embodiment of the invention. The target audio signal 2000 is passed as input to the speaker encoder 2010 to produce a speaker embedding. The speaker encoder is pretrained, usually on a speaker verification task, and its weights are fixed during TTS training. The speaker vector, together with the input text 2020 are passed as input to the TTS network 2030, which generates as output a representation of the synthesized audio signal, such as a Mel spectrogram. The equivalent representation is computed for the target audio signal and the two signals are compared with a loss 2040, such as the log-Mel reconstruction loss.

Various systems, components, services or micro-services, and functional blocks are described herein for processing audio and video, corresponding speech, silence, voices and background noise embedded in the video, and speech recognition and machine translation (collectively components). These components may be implemented in software instructions stored in memory that are executed by a processor such as a microprocessor, GPU, CPU or other centralized or decentralized processor and may run on a local computer, a local server or in a distributed cloud environment. The processor may further be coupled to input/output devices including network interfaces for streaming video or audio or other data, databases, keyboards, mice, displays, speakers and cameras, among others. These components all of those identified herein, including ffmpeg associated with basic signal processing, and ASR, MT, speech separation, audio segmenter, case and punctuation systems, visual diarization systems, speaker diarization, speech rate prediction, speech placement system, speaker encoders, decoders, emotion classifiers for text and speech, TTS and speaker adaptive TTS. In addition, some components described herein comprise models that may be implemented and trained with AI, machine learning and deep neural networks. These may include any of the components above, but particularly the ASR, MT, and TTS functionality and also other components described herein as implementing trained models or neural networks. The memory may store training models, data and operational models and programs for training translation MT embodiments, ASR embodiments, TTS embodiments and embodiments of other components described herein.

While particular embodiments of the present invention have been shown and described, it will be understood by those having ordinary skill in the art that changes may be made to those embodiments without departing from the spirit and scope of the present invention.

What is claimed is:

1. A speaker-adaptive system for dubbing in different languages, comprising:
inputs configured to receive translated text in a target language, an original audio stream, and at least one speaker feature vector corresponding to at least one speaker represented as speech in the original audio stream, wherein the original audio stream includes speech in a first language different from the target language; and
a trained TTS system capable of receiving the inputs and synthesizing voices in the target language, wherein in response to receiving the inputs, the trained TTS system is configured to synthesize voices as output in the target language based on the at least one speaker feature vector and the original audio that controllably sound like the at least one speaker in the original audio.

2. The system according to claim 1, further comprising:
a speech emotion classifier that is capable of receiving speech in the first language and generating an emotion label based on the speech; and
wherein the trained TTS system is capable of receiving the emotion label and synthesizing the voices as output in the target language based further on the emotion label.

3. The system according to claim 1, further comprising:
a speech emotion classifier that is capable of receiving speech segments in the first language corresponding to one of at least two speakers represented in the original audio and generating an emotion vector based on the speech in the speech segment; and
wherein the trained TTS system is further capable of synthesizing the voices as output in the target language based on the speaker represented in the speech segment, the speaker vector and the emotion vector for the segment.

4. The speaker-adaptive system according to claim 3, further comprising:
a signal processing system that receives the audio output of the trained TTS system and original audio and reproduces corresponding audio conditions present in the original audio stream together with the synthesized speech in the target language.

5. The speaker-adaptive system according to claim 1, further comprising:
a signal processing system that receives the audio output of the trained TTS system and original audio and reproduces corresponding audio conditions present in the original audio stream together with the synthesized speech in the target language.

6. A video dubbing system for automatically dubbing a video signal into a different target language than the original audio while keeping vocal characteristics of original speakers in the audio, comprising:
a speech separation system capable of processing an audio signal in a video signal and splitting it into a speech signal and a background signal;
an audio segmenter capable of detecting voice and non-voice segments in the audio signal;
an ASR system associated with at least one language in the audio signal that is capable of outputting words in sequence and their time stamps;
a casing and punctuation system that is capable of transforming the word sequence from the ASR system into human readable text with casing and punctuation;
a visual diarization system capable of receiving the video signal and outputting prior probabilities on the number of speakers in the video based on face detection, lips movement detection and face recognition models;
a speaker diarization system capable of receiving the voice segments in the audio signal and assigning speaker labels to the voice segments and re-segmenting the audio signal according to the speaker labels;
a MT system with length control capable of outputting isochronic translations of the human readable text associated with the audio signal;
a speech rate prediction system that is capable of outputting deviations from a normal speech rate;
a speech placement system that, for each utterance in the translated text, is capable of assigning time stamps to it based on its duration, on/off screen voice information, and surrounding silence and can also change the speaking rate of each utterance;
a speaker encoder that is capable of extracting speaker feature vectors from audio speech segments;
a speech emotion classifier that is capable of receiving audio speech segments and outputting speech emotion label information;
a text emotion classifier that is capable of receiving text for a speech segment and outputting text emotion label information that can be expressed by the content of the text;
a speaker-adaptive TTS system that is capable of (i) receiving translated text in a target language, an original audio stream, and at least one speaker feature vector corresponding to at least one speaker represented in the original audio stream, and (ii) synthesizing voices in the target language that controllably sound like the at least one speaker in the original audio; and
a signal processing system that is capable of concatenating synthesized audio signals from the TTS system intertwined with silence according to timings provided by the speech placement system, blending background audio with the concatenated synthesized audio signals to generate a translated audio signal and merging the translated audio signal with the original video signal to generate a new dubbed video signal.

7. The System according to claim 6, where the original audio signal may have a monaural audio signal or multiple audio channels.

8. The System according to claim 6, wherein the ASR system may be provided with an additional custom lexicon for recognizing domain-specific words.

9. The system according to claim 6, wherein speaker diarization is further based on the face detection corresponding to a segment of speech by one of the speakers.

10. The system according to claim 6, wherein the speech emotion label information is predicted emotions that are used to index an emotion embedding matrix that is provided as input to the TTS system.

11. The system according to claim 10, wherein the text emotion classifier label information is combined with the predicted emotions and the combination used to index the emotion embedding matrix.

12. The system according to claim 6, wherein one of multiple translation hypotheses with different output lengths from the MT output are chosen based on a best-fitting translation during speech placement.

13. The system according to claim 12, wherein the MT system is dialogue-aware and translates considering past context.

14. The system according to claim 6, wherein one or more of the component systems are deployed as microservices made available over networks from a cloud based system.

15. The system according to claim 14, further comprising a web based editing system that receives updated video and allows for post-editing transcriptions, translations, segments, segment time markers, speaker labels and new dubbing.

16. The system according to claim 15, wherein the editing system further allows the edit of emotion labels.

17. The system according to claim 15, wherein the editing system further allows modifying speech signal characteristics, including at least one of: pitch contour, energy, single phonemes, and phoneme durations.

18. The system according to claim 15, wherein the MT system is provided with meta data including at least one of: speaker or receiver gender, formality, and dialect and produces different translations based on this meta data.

19. A speaker-adaptive method for dubbing in different languages, comprising:
receiving translated text in a target language, an original audio stream, and at least one speaker feature vector corresponding to at least one speaker represented as speech in the original audio stream, wherein the original audio stream includes speech in a first language different from the target language; and
synthesizing voices in the target language based on the original audio stream and the at least one speaker feature vector corresponding to at least one speaker represented as speech in the original audio stream that controllably sounds like the at least one speaker in the original audio.

20. The method according to claim 19, further comprising:
generating an emotion label based on based on the speech in the first language; and
synthesizing the voices as output in the target language based further on the emotion label.

21. A system for speaker-adaptive dubbing in different languages, comprising:
a memory that stores program instructions for execution to process an audio stream that includes speech in a first language and text in a target language corresponding to the speech;
an input/output unit that receives video and audio signals and data; and
a processor, coupled to the memory, that is capable of executing the program instructions to (i) receive translated text in a target language, an original audio stream, and at least one speaker feature vector corresponding to at least one speaker represented as speech in the original audio stream, wherein the original audio stream includes speech in a first language different from the target language, and (ii) synthesize voices in the target language based on the original audio stream and the at least one speaker feature vector corresponding to at least one speaker represented as speech in the original audio stream that controllably sounds like the at least one speaker in the original audio.

22. The system according to claim 19, wherein the processor is further configured to execute the program instructions to:
generate an emotion label based on based on the speech in the first language; and
synthesize the voices as output in the target language based further on the emotion label.
